(19) United States
(12) Patent Application Publication
(10) Pub. No.: US 2009/0165549 A1
(43) Pub. Date: Jul. 2, 2009

(54) Device and method for testing an optical rain sensor

(76) Inventors: Ansgar Grass, Schutterwald-Langhurst (DE); Reinhold Fiess, Durbach (DE); Frank Wolf, Buehl (DE); Mathias Mannhardt, Achern (DE); Andreas Pack, Haguenau (DE)

Correspondence Address: KENYON & KENYON LLP, ONE BROADWAY, NEW YORK, NY, 10004, US

(21) Appl. No.: 11/630,089

(22) PCT Filed: Jun. 7, 2005
(86) PCT No.: PCT/EP05/52603

§ 371 Date: Oct. 14, 2008

(30) Foreign Application Priority Data
Jun. 22, 2004 (DE) 10 2004 030 191.3

(51) Int. Cl. G01W 1/14; G01N 21/85

(52) U.S. Cl. 73/170.17; 250/574

(57) ABSTRACT

A testing device is provided for testing an optical rain sensor which is designed to determine a measure of moisture by determining a reflected portion of a light beam, which testing device has a mounting device for holding the rain sensor and test equipment which is positioned in the light beam, movably, for example, the test equipment having an area which is designed to reflect a predefined portion of the light beam.

### FIELD OF THE INVENTION

The present invention relates to a device and a method for testing an optical rain sensor, and relates in particular to an optical rain sensor for use in a motor vehicle.

### BACKGROUND INFORMATION

In rain sensors used in today's motor vehicles, an optoelectronic principle is mostly used for rain detection. Such a rain sensor normally has a light source, a photodetector, and a fiber optic element. The light beam emitted by the light source is injected into the fiber optic element. The rain sensor is attached to a windshield pane, for example, with the aid of a transparent adhesive film, so that light from the fiber optic element is injected into the windshield pane and reflected on the external surface of the windshield pane by total reflection, for example. The reflected light beam is directed back via the same or another fiber optic element toward the photodetector. If there is a water droplet on the pane surface, the light beam is interrupted at this point of the external pane surface, and the light intensity that reaches the photodetector is reduced accordingly. This reduction in intensity is analyzed, and rain or condensation on the windshield pane is thereby recognized.

To test the operation of the above-described rain sensors, a testing method is known in which the rain sensor is mounted on a test pane and the transmission of the optical channels is analyzed. Furthermore, it is known to measure the sensitive surfaces with the aid of a silicone stamp, which affects, to a defined degree, the path of the light beam emitted by the light source, so that a measure of the reliability performance of the rain sensor is obtained from a change in the measured quantity between the state before the application of the silicone stamp and with the silicone stamp applied.

An object of the present invention is to provide a testing device and testing method for testing the operation of a rain sensor under defined conditions. In particular, an object of the present invention is to provide a testing device and a method for testing the operation of the rain sensor in dynamic operation.

### SUMMARY

According to a first aspect of the present invention, a testing device is provided for testing an optical rain sensor. The optical rain sensor is designed to determine a measure of moisture by determining a reflected portion of a light beam. The testing device furthermore includes a mounting device for securing the rain sensor during the test. Furthermore, test equipment is provided in particular which is placeable in the light beam, the test equipment having an area in particular which is configured to reflect a predefined portion of the light beam.

The testing device according to the present invention has the advantage that a rain sensor is testable in a defined way with the aid of test equipment. The sensor is coupled, with the aid of the test equipment, to an area having certain optical reflection characteristics, so that the reflected predefined portion of the light beam is affected in a predefined manner. The operability of the rain sensor may be tested with the aid of these predefined optical characteristics. Contrary to known testing devices, the testing device according to the present invention allows reproducible test results to be obtained, which make objective evaluation of the rain sensor's operation possible. Furthermore, the free selection of the configuration of the test equipment area to be placed in the light beam allows free selection of the conditions under which the optical rain sensor is tested.

The mounting device and the testing device may be situated movably with respect to one another.

The test equipment has at least one reflection element to reflect a portion of the light beam into the optical rain sensor. Additionally or alternatively, the test equipment may have, in one area, a deflection element which is designed to change the angle of a total reflection of the light beam at one point of the test equipment. In particular, the test equipment may be transparent for this purpose, and the deflection element may be provided as a knob-shaped elevation in the area on a surface of the test equipment. This permits testing the optical rain sensor under conditions essentially corresponding to real-life conditions in that droplets on a windshield pane are simulated with the aid of the knob-shaped elevations on the test equipment, so that the reflection characteristics of the light beam in the testing device essentially correspond to the actual reflection characteristics of the light beam in the windshield pane having droplets on its external surface.

The test equipment may have a plurality of areas, each with different reflection characteristics to test a mounted rain sensor under different reflection conditions.

According to an example embodiment of the present invention, the test equipment may be designed as a rotatable test disk, which is displaceable axially in particular. The rotatable test disk may have a plurality of areas having different reflection characteristics, so that the reflected portion of the light beam is varied by rotating the test disk. In particular, the test disk may have a calibration area for calibrating the mounted rain sensor. From the changes in a measured value detected by the optical rain sensor, it may be determined whether the rain sensor is operating properly. The optional axial displaceability of the test equipment (in the axial direction) makes it possible to simulate different pane thicknesses of the windshield pane on which the rain sensor to be tested will be mounted in the final application. To obtain the least possible disturbance of the reflected portion of the light beam between the test equipment and the mounting device, the test equipment may be placed, at least partially, in an immersion liquid, e.g., silicone oil or glycerin.

According to another example embodiment of the present invention, the mounting device may be designed as an at least partially transparent disk. In particular, the mounting device may have at least two different areas having different transmissions, in particular a tinted and a non-tinted area. This permits the rain sensor to be tested for different pane transmissions as may occur in the later use due to the different tints of the windshield pane.

According to a further aspect of the present invention, a method for testing an optical rain sensor is provided which determines a measure of moisture by determining a reflected portion of a light beam. The method includes the steps of mounting the rain sensor, introducing an area of test equipment into the light beam, so that a predefined portion of the light beam is reflected on the rain sensor, and determining a measured value with the aid of the rain sensor.

The method according to the present invention makes it possible to test rain sensors using a reproducible testing method, which allows an objective evaluation of the reliability performance of the rain sensor. The method defines an actual measuring situation for the rain sensor, i.e., the dynamic response of the rain sensor is reproducible.

The test equipment may have a plurality of areas having different reflection states, the test equipment being moved in the light beam in such a way that the plurality of areas are moved through a sensitive surface of the rain sensor to determine a plurality of measured values for different reflection states. In this way, the rain sensor may be tested for different precipitation conditions.

To test the rain sensor, the determined measured value(s) is (are) preferably compared with one or more setpoint values, so that the reliability performance of the rain sensor may be tested via the correspondence or deviation of these values.

### BRIEF DESCRIPTION OF THE DRAWINGS

FIG. 1 shows a testing device according to a first example embodiment of the present invention.

FIG. 2 shows a testing device according to another example embodiment of the present invention.

FIG. 3 shows a top view of the test disk of the embodiment of FIG. 2.

FIG. 4 shows a top view of the container bottom of the embodiment of FIG. 2.

FIG. 5 shows a top view illustrating the container bottom and a displaceable test equipment according to another example embodiment of the present invention.

FIG. 6 shows a testing device according to another example embodiment of the present invention.

FIG. 7 shows a block diagram of a testing system for carrying out the testing method according to an example embodiment of the present invention.

### DETAILED DESCRIPTION

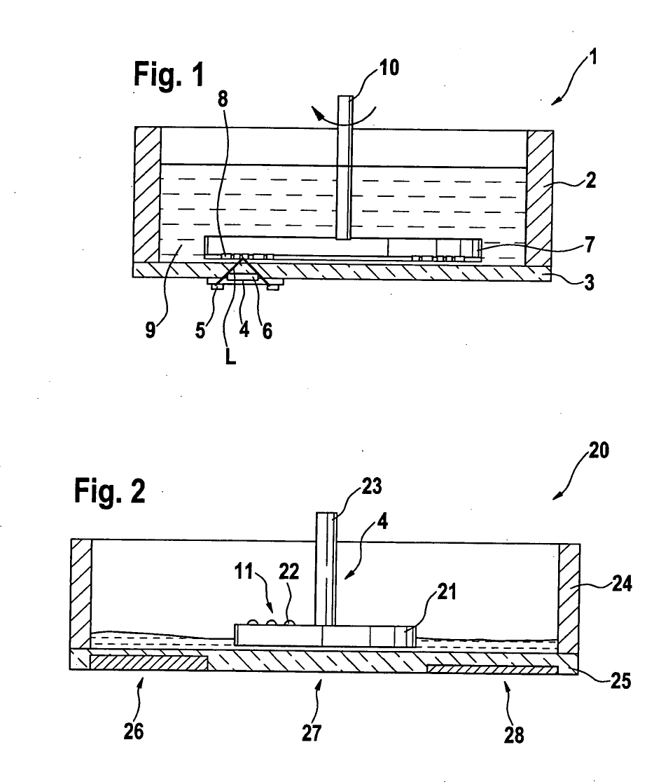

FIG. 1 shows a testing device according to a first example embodiment of the present invention. Testing device 1 includes a container 2 having at least partially transparent container bottom 3. An optical rain sensor 4 to be tested is mounted on the outside of container bottom 3, for example, with the aid of a suitable bracket 5, an adhesive, or some other fastening means. Optical rain sensor 4 includes a light source, for example, in the form of a laser diode (not shown) and a photodetector (not shown). The light source injects a light beam into a coupling element (not shown) of the rain sensor, which directs the light beam onto a boundary surface. On this boundary surface, the light beam is reflected onto the photodetector by total reflection, for example. If there is moisture in the form of condensation or droplets on the boundary surface on which the light beam is reflected, the critical angle of the total reflection is modified, whereby part of the light is reflected into the atmosphere at the surface and only a small portion of the light emitted by the light source is reflected into the photodetector. The moisture on the surface may thus be detected via the reduced light intensity which is received by the photodetector of the rain sensor.

To prevent, to the degree possible, the light beam from being scattered or reflected, entirely or partially, on undesirable boundary surfaces before or after hitting the boundary surface, rain sensor 4 is connected to the container bottom, for example, attached to container bottom 3 with the aid of a silicone pad 6, so that the light beam emitted by the light source of rain sensor 4 is injected into container bottom 3 with minimum or no loss.

A test disk 7 which is rotatably suspended on a rotation shaft 10 and may be moved with the aid of a drive (not shown) is situated in container 2. Test disk 7 may be designed as a circular rotating plate, but may also have a different shape, such as a rectangle, for example. There is a variable distance between the internal surface of container bottom 3 and test disk 7. The bottom of test disk 7 is provided with reflection elements 8, which may be designed in the form of a mirror layer, for example. The mirror layer is implemented, for example, by an aluminum coating and may have different designs in different areas of test disk 7. The different areas, which may be designed as disk segments, may have mirror coating patterns to simulate different reflection characteristics. The mirror coating patterns have alternating mirror-coated, partially mirror-coated, and/or non-mirror-coated sections in particular.

To prevent light beam L from being reflected on the internal surface of container bottom 3, for example, by total reflection, container 2 is filled with an immersion liquid 9 such as, for example, silicone oil, glycerin or the like. Container 2 is filled with a quantity of immersion liquid 9 which is sufficient for wetting at least reflection elements 8 with immersion liquid 9. In this way the light beam is prevented from having to pass, between the internal surface of container bottom 3 and reflection elements 8, through a boundary surface between media having different refraction indices on which the light beam would be deflected. In this way, boundary surfaces on which the light beam is deflected or weakened through total reflection are avoided.

Reflection elements 8 are situated in a predefined manner on test disk 7. The arrangement of reflection elements 8 determines the portion of light beam L that is reflected in test disk 7 back onto the photodetector of rain sensor 4. Of course, test disk 7 may also have an area which is fully mirror-coated, so that light beam L is fully reflected.

The height of test disk 7 is (axially) variably adjustable along its rotation shaft 10, so that reflection elements 8 may be situated at different distances from rain sensor 4 to simulate different thicknesses of the windshield pane. The filling height of immersion liquid 9 in the container is selected in such a way that reflection elements 8 remain covered by immersion liquid 9 for any height setting of test disk 7.

Immersion liquid 9 is selected in such a way that it has a high degree of transmission, e.g., >95%, so that the degree of transmission of the entire test section is essentially determined exclusively by test disk 7, i.e., reflection elements 8 situated thereon.

Another example embodiment of a testing device according to the present invention is illustrated in FIG. 2. Testing device 20 differs from the testing device of FIG. 1 by the fact that a test disk 21, essentially made of transparent glass or plastic, is provided as test equipment. There are deflection elements 22 on the top of test disk 21, which, like reflection elements 8 of the embodiment of FIG. 1, are situated in a certain predefined pattern. Test disk 21 is rotatable about its rotation shaft 23 and movable with the aid of a drive to insert different reflection areas of test disk 21 into the light beam relevant to the rain sensor (not illustrated in this embodiment). Container 24 of testing device 20 has a container bottom 25, which has different partial areas, a first area 26 having a strong tint, i.e., a high transmission loss of a passing light beam, second area 27 having no tint, and a third area 28 having a slight tint, i.e., a low transmission loss for a passing light beam. Test disk 21 is movable horizontally in container 24 also with the aid of the drive, so that the test disk is movable over one of the three areas 26, 27, 28. In this way a function of a rain sensor 4, which is placed on or attached to the external surface of container bottom 25 in one of the three areas 26, 27, 28, may be tested for different pane tints. This allows the reliability performance of the rain sensor to be tested accordingly for a later use on tinted windshield panes.

Instead of the horizontal displacement of the test disk, alternatively container 24 may also be displaced horizontally against a stationary test disk.

As in the first exemplary embodiment, the height of test disk 21 is adjustable, the distance between the outside of container bottom 25 and the top of test disk 21 being equal to the simulated thickness of the windshield pane.

In the exemplary embodiment of FIG. 2, there is also immersion liquid in container 24, which has, as previously, a refraction index that is essentially equal to that of container bottom 25 and test disk 21. The immersion liquid should not wet deflection elements 22 in order not to impair the deflection effect of the light beam passing through test disk 21. Instead of deflection elements 22, which are placed in the form of droplets on the top of test disk 21, depressions or structures having a similar or identical effect may also be situated on the top of test disk 21 to achieve an appropriate deflection of the light beam.

Deflection elements 22, applied to test disk 21, may be made of solidified droplets (e.g., of epoxy resin), which modify the angle of total reflection on the boundary surface formed by the top of test disk 21 and thus simulate the effect of a water droplet on the top of test disk 21. Due to the resulting change in the total reflection angle, part of the light beam emitted by the rain sensor to be tested is not reflected back into the photodetector, but is emitted into the surroundings. This permits simulating the operation of the rain sensor under conditions as close to reality as possible (drops on an external surface of a windshield pane). By rotating test disk 21, different areas may be passed over the rain sensor, so that a change in the thickness of deflection elements 22 in the light beam of the rain sensor may be achieved, thus simulating the different amounts of droplets on a windshield pane.

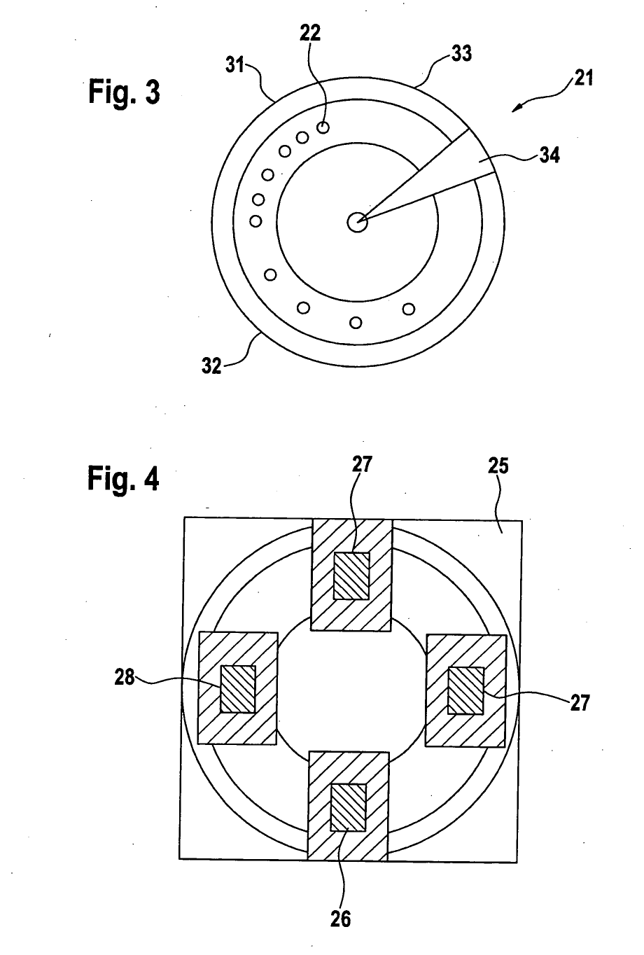

FIG. 3 shows a top view onto a test disk 21 of the embodiment shown in FIG. 2, which has different segments having different types of structuring. In particular, reflection elements 8 may also be provided in the form of mirror surfaces as in the first embodiment, or mirror surfaces and deflection elements may be combined on test disk 21. Test disk 21, which is illustrated in FIG. 3, has areas, preferably a first sector 31 and a second sector 32, which have deflection elements 22 having different thicknesses. In the example shown, first segment 31 has a greater thickness of deflection elements 22 than second segment 32. In an additional, third, segment 33, test disk 21 has no deflection elements to simulate the function of the rain sensor in the case of a dry windshield pane. Furthermore, a fourth segment 34 is provided, in which test disk 21 is blackened to simulate the passage of a windshield wiper and check its effect on the function of the rain sensor.

In the case of reflection elements 8, one or more of the segments which are partially mirror-coated may be provided with recesses between mirror-coated elements, because water droplets on a windshield pane have a certain residual reflection, which is thereby simulated. To properly simulate such a residual reflection, the recesses are provided as partly mirror-coated areas, which are formed, for example, by a honeycomb structure of smaller, fully mirror-coated and non-mirror-coated areas.

FIG. 4 shows a top view onto container bottom 25 of the embodiment of FIG. 2. The figure shows different areas 26, 27, 28, where container bottom 25 has different tints to simulate, in testing the rain sensor, different tints of the windshield pane on which the rain sensor will later be used.

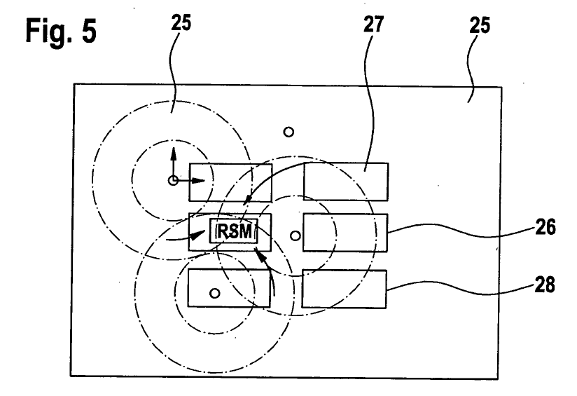

FIG. 5 shows a top view onto the testing device of FIG. 2. The figure shows an alternative for another arrangement of different tinted areas 26, 28 in container bottom 25, test disk 21 being able to move laterally in container 24 with the aid of the drive to test a rain sensor situated in one of the areas on the outside of container bottom 25 by moving a certain pattern of deflection elements 22 on test disk 21 from different directions, so that the rain sensor may be tested in different operating states.

To determine a sensitive area of a rain sensor to be tested, it is advantageous that the test disk have a sector on which only one single deflection element 22 is situated. This deflection element 22 is passed once or multiple times over the sensitive surface of the rain sensor to determine the extension of the sensitive surface of the rain sensor. The sensitive surface is determined by determining the positions in which deflection element 22 affects the measured values determined with the aid of the rain sensor.

A possible sequence of a testing procedure is described below. First, test disk 21 is placed over the rain sensor to be tested in such a way that the light beam emitted by the rain sensor hits a deflection element (and/or a reflection element) on the test disk from where it is fully or partially reflected to the photodetector of the rain sensor. In such a defined state, the system adjusts to the state which corresponds to the later use of a dry windshield pane. To test the rain sensor, test disk 21 is now rotated, so that a droplet pattern (non-mirror-coated areas of the test disk or sectors having deflection elements) of the next segment moves over the sensitive surface of the rain sensor. In this sector the light beam is partially deflected over the non-mirror-coated or partially mirror-coated areas or the pattern of deflection elements 22, so that the photodetector detects a reduction in the light intensity. The intensity of the detected signal is determined by the configuration of the area. The pattern of deflection elements or partially mirror-coated areas may correspond to actual rain situations.

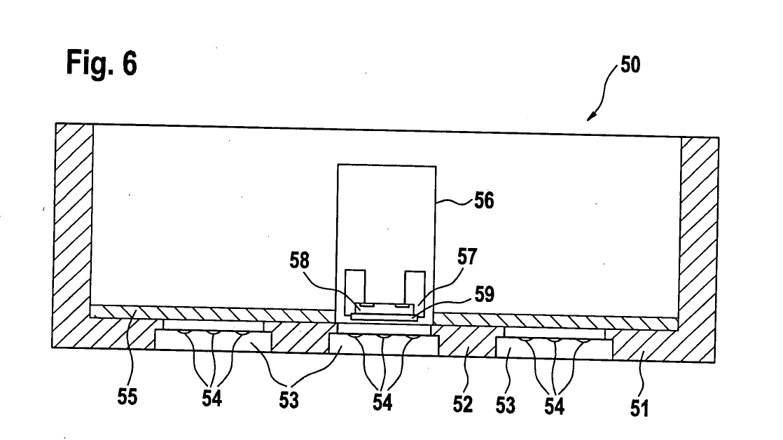

FIG. 6 shows another testing device 50 according to a further example embodiment of the present invention, in which an essentially stationary container 51 is provided. A bottom 52 of container 51 has fully or partially transparent areas 53 which are provided with deflection elements 54 to simulate a windshield pane wetted by droplets. There is an immersion liquid 55 in the container.

A holding device 56 is provided, which is movable, for example, with the aid of a robot arm (not shown) within container 51. Holding device 56 has a recess 57, in which rain sensor 58 to be tested may be placed and held. Rain sensor 58 is preferably covered with a transparent disk 59, so that rain sensor 58 is optically coupled to disk 59. Disk 59 is used for preventing rain sensor 58 from coming in direct contact with immersion liquid 55. For this purpose, disk 59 fully covers recess 57, so that no immersion liquid may penetrate into recess 57. An appropriate gasket may be provided, if necessary.

Holding device 56 is moved in container 51 on or over the transparent areas with the aid of the robot arm, so that the sensitive area of rain sensor 58 is optically coupled to disk 59 and immersion liquid 55. By moving holding device 56, the static response or dynamic response of rain sensor 58 may be tested.

As in the other example embodiments described previously, transparent areas 53 and/or disk 59 may have a tint to simulate a tinted windshield. Furthermore, deflection elements 54 may also be provided as transparent elevations or depressions on container bottom 52. Alternatively or additionally, all or part of areas 53 may also be provided with reflection elements. Different pane thicknesses may be simulated via the adjustable height of holding device 56 in container 51, or by defining the immersion depth of holding device 56 in immersion liquid 55. In this embodiment, the test method may be carried out in the same way as explained with reference to the previously described embodiments.

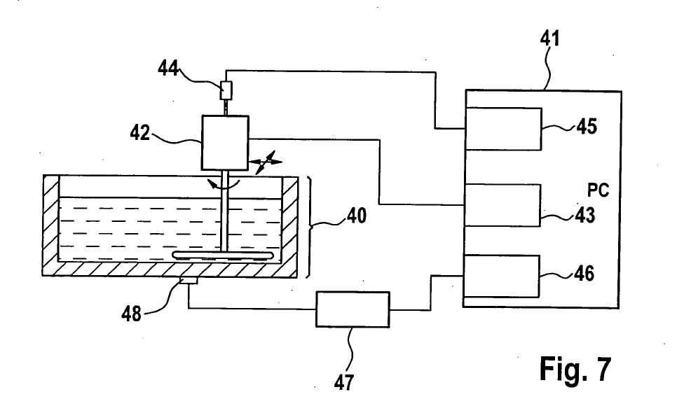

FIG. 7 shows a testing system in which a testing device 40 as described previously in connection with the embodiments of FIGS. 1 through 5 is connected to an analyzer system 41. Analyzer system 41 controls the lateral motion and rotation of the rotating disk of testing device 40 with the aid of a drive 42, which is controlled via a motor interface 43 in analyzer system 41. The rotation shaft, which is connected to the test disk, is connected to a position sensor 44, which transmits the position of the rotating disk to a position detector 45 of analyzer system 41. Furthermore, an interface 46 is provided for the rain sensor in analyzer system 41, which is connected, via a suitable bus interface 47, for example, to rain sensor 48 situated on the bottom of testing device 40 in a testing area.

A test may be performed by initially testing rain sensor 48 under a test condition corresponding to a dry windshield pane, for example, as described previously. Subsequently drive 42 is operated with the aid of motor interface 43 in such a way that a pattern of reflection elements and/or deflection elements is moved over the sensitive surface of the rain sensor to simulate dynamic rain on a windshield pane. The corresponding measured values are detected via interface 46 in analyzer system 41 and compared, for example, with setpoint values which correspond to the measured values for a correctly operating ideal rain sensor. When the values correspond exactly or within a predefined tolerance range, the rain sensor is recognized as operating properly; otherwise, it is not.

To simulate a shutoff sequence for a windshield wiper controlled via analyzer system 41, the test disk may have a pattern of deflection elements 22 in which the thickness of the deflection elements decreases with increasing angular path, so that the response of the rain sensor in the event of a subsiding rain may be determined.

1-14. (canceled)

15. A testing device for testing an optical rain sensor that determines a measure of moisture by determining a reflected portion of a light beam, comprising:
a housing;
a mounting device for mounting the optical rain sensor to the housing; and
a test equipment positioned in a path of the light beam, the test equipment having an area configured to reflect a predefined portion of the light beam.

16. The testing device as recited in claim 15, wherein the mounting device and the test equipment are situated movably with respect to one another.

17. The testing device as recited in claim 16, wherein the test equipment has at least one reflection element in the area configured to reflect a predefined portion of the light beam, whereby the at least one reflection element reflects the predefined portion of the light beam into the optical rain sensor.

18. The testing device as recited in claim 16, wherein the test equipment has a deflection element in the area configured to reflect a predefined portion of the light beam, wherein the deflection element changes an angle of a total reflection of the light beam at the test equipment.

19. The testing device as recited in claim 18, wherein the test equipment is substantially transparent and the deflection element is configured as a knob-shaped elevation on a surface of the test equipment.

20. The testing device as recited in claims 16, wherein the test equipment has a plurality of areas having different reflection characteristics, whereby the plurality of areas enable testing of a mounted optical rain sensor for different reflection states.

21. The testing device as recited in claim 16, wherein the test equipment is a rotatable test disk, and wherein the rotatable test disk is configured to be selectively displaced at least one of axially and radially.

22. The testing device as recited in claim 21, wherein the test disk has a calibration area.

23. The testing device as recited in claim 16, wherein the test equipment is at least partially situated in an immersion liquid.

24. The testing device as recited in claim 16, wherein the mounting device is a disk that is at least partially transparent.

25. The testing device as recited in claim 24, wherein the mounting device has at least two different areas having different transmission characteristics.

26. A method for testing an optical rain sensor that determines a measure of moisture by determining a reflected portion of a light beam, the method comprising:
mounting the optical rain sensor to a housing of a testing system using a mounting device, the testing system including a test equipment;
positioning a selected area of the test equipment in a path of the light beam, wherein a predefined portion of the light beam is reflected by the selected area onto the optical rain sensor; and
determining a measured quantity with the aid of the optical rain sensor.

27. The method as recited in claim 26, wherein the test equipment has a plurality of areas having different reflection states, and wherein the test equipment is moved in the light beam in such a way that the plurality of areas are moved over a detection surface of the optical rain sensor, whereby the optical rain sensor determines a plurality of measured quantities for different reflection states.

28. The method as recited in claim 26, wherein the determined measured quantity is compared with at least one setpoint value.
